(19) United States
(12) Patent Application Publication
(10) Pub. No.: US 2014/0077569 A1
(43) Pub. Date: Mar. 20, 2014

(54) Telescopic Spa & Tub Footrest Pole

(71) Applicant: Daniel Gordon Wilson, Coldstream (CA)

(72) Inventor: Daniel Gordon Wilson, Coldstream (CA)

(21) Appl. No.: 14/014,008

(22) Filed: Aug. 29, 2013

Related U.S. Application Data
(60) Provisional application No. 61/743,956, filed on Sep. 17, 2012.

(51) Int. Cl. A61H 33/00

(52) U.S. Cl. CPC A61H 33/6005
USPC 297/423.39

(57) ABSTRACT

The invention is a telescopic pole with a locking mechanism to be utilized as a footrest in hot tubs. The invention works by extending said pole in length to reach from one wall to the opposite wall of a hot tub by engaging said locking mechanism said pole is locked to said length +½″ said locked pole is then wedged into place between said hot tub walls.

### INVENTION DESCRIPTION

The invention is constructed of a telescopic pole which includes a locking mechanism capable of locking said pole at various lengths (FIG. 2), two rubber feet (FIG. 4) are attached to both ends of the said pole and a foam tube (FIG. 3) is placed over the outside of said pole.

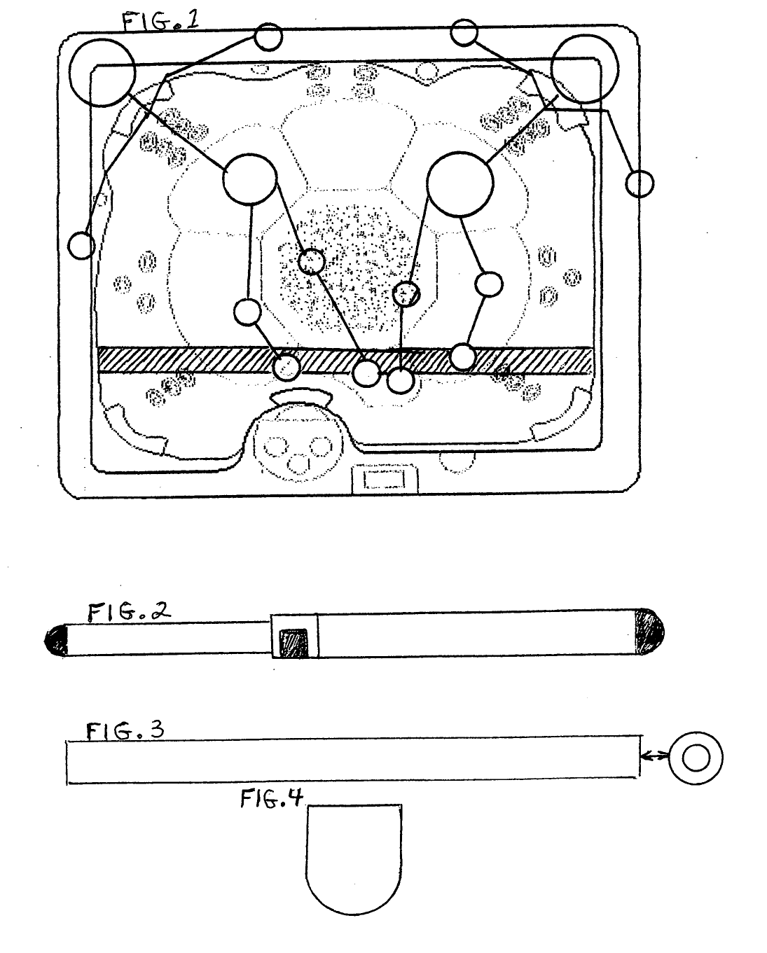

The invention works by extending said pole in length to reach from one wall to the opposite wall of a tub or spa then by engaging said locking mechanism said pole is locked to said length +½″ said locked pole is then wedged into place between the said walls (FIG. 1).

What is claimed is:

1. A moveable hot tub footrest pole comprising a) Telescopic pole B) A locking mechanism capable of locking said pole at desired lengths c) Two rubber feet placed on the ends of said pole providing friction against hot tub walls when said pole is locked to a desired length and wedged between said walls. D) A foam tube placed over the outside of said pole for the purpose of providing a cushioning surface.

2. A moveable footrest pole where in the pole further comprises a compressible spring mechanism.

3. A moveable hot tub footrest pole further utilizing capture plugs such that the ends of said pole are held in place by capture plugs secured to said hot tub walls.
